(19) United States
(12) Patent Application Publication
(10) Pub. No.: US 2008/0250165 A1
(43) Pub. Date: Oct. 9, 2008

(54) USB port access management

(76) Inventors: Eddy Reynolds, Houston, TX (US); Luke Mulcahy, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/732,280

(22) Filed: Apr. 3, 2007

(51) Int. Cl. G06F 3/00

(52) U.S. Cl. 710/17

(57) ABSTRACT

In one embodiment an electronic apparatus comprises a processor, an operating system, a basic input/output system, and logic to detect a connection of a device to a USB port, in response to the connection, generate a system management interrupt that causes the basic input/output system to assume control of the electronic apparatus, determine, in the basic input/output system, whether the device comprises storage, determine whether the USB port is configured to accept a storage device, and initiate a routine to block access to the USB port in the event that the device comprises storage.

### BACKGROUND

Security, and particularly data security, remains an important issue in the computer industry. In some environments it may be useful to block universal serial bus (USB) mass storage devices from functioning on computer systems or other electronic apparatus, e.g., to prevent users from downloading data to the USB storage device.

### BRIEF DESCRIPTION OF THE DRAWINGS

FIG. 1 is a schematic illustration of one embodiment of an electronic apparatus adapted to implement USB port access management.

FIG. 2 is a flowchart illustrating operations in one embodiment of implementing USB port access management.

### DETAILED DESCRIPTION

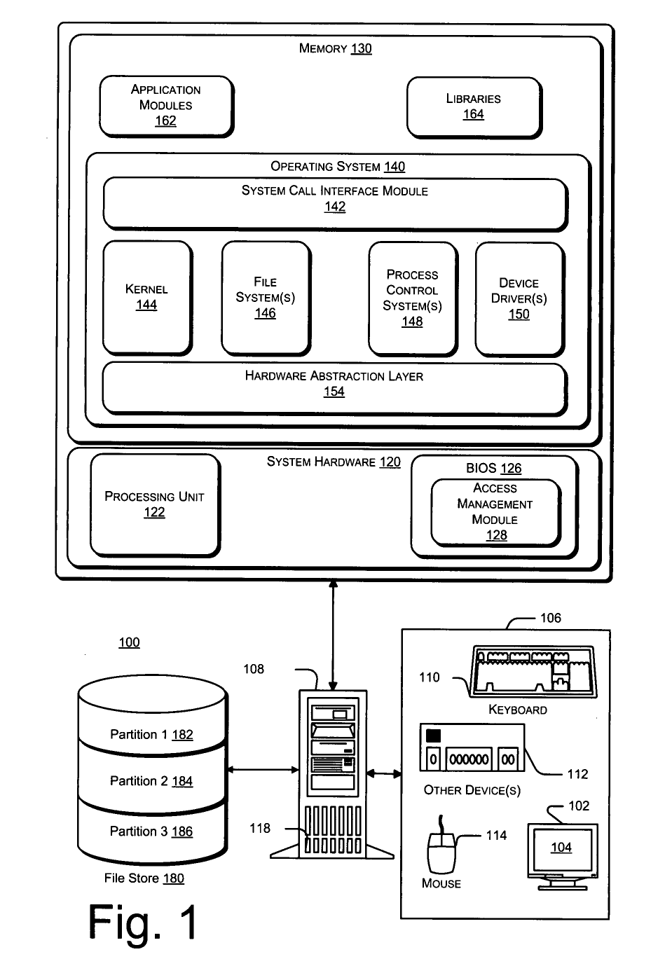

FIG. 1 is a schematic illustration of one embodiment of an electronic apparatus adapted to implement USB port access management, according to an embodiment. In the illustrated embodiment, device 100 may be embodied as a hand-held or stationary device for accessing the Internet, a desktop PC, notebook computer, personal digital assistant, or any other processing devices that have a basic input/output system (BIOS) or equivalent.

In the embodiment depicted in FIG. 1, the electronic apparatus 100 includes a computer 108 and one or more accompanying input/output devices 106, which may include a display 102 having a screen 104, a keyboard 110, other I/O device(s) 112, and a mouse 114. The other device(s) 112 may include, for example, a touch screen, a voice-activated input device, a track ball, and any other device that allows the system 100 to receive input from a developer and/or a user. The computer 108 includes system hardware 120 including a processing unit 126, a disk controller 128, and random access memory and/or read-only memory 130. Input/output devices 106 may be coupled to computer 108 by a suitable input/output interface such as, e.g., a universal serial bus (USB) port 118.

A file store 180 is communicatively connected to computer 108. File store 180 may be internal such as, e.g., one or more hard drives, or external such as, e.g., one or more external hard drives, network attached storage, or a separate storage network. File store 180 comprises may comprise one or more partitions 182, 184, 186.

Memory 130 includes an operating system 140 for managing operations of computer 108. In one embodiment, operating system 140 includes a hardware abstraction layer 154 that provides an interface to system hardware 120. In addition, operating system 140 includes a kernel 144, one or more file systems 146 that manage files used in the operation of computer 108 and a process control subsystem 148 that manages processes executing on computer 108. Operating system 140 further includes one or more device drivers 150 and a system call interface module 142 that provides an interface between the operating system 140 and one or more application modules 162 and/or libraries 164. The various device drivers 150 interface with and generally control the hardware installed in the electronic apparatus 100.

In operation, one or more application modules 162 and/or libraries 164 executing on computer 108 make calls to the system call interface module 142 to execute one or more commands on the computer's processor. The system call interface module 142 invokes the services of the file system(s) 146 to manage the files required by the command(s) and the process control subsystem 148 to manage the process required by the command(s). The file system(s) 146 and the process control subsystem 148, in turn, invoke the services of the hardware interface module 154 to interface with the system hardware 120. The operating system kernel 144 can be generally considered as one or more software modules that are responsible for performing many operating system functions.

The particular embodiment of operating system 140 is not critical to the subject matter described herein. Operating system 140 may be embodied as a UNIX operating system or any derivative thereof (e.g., Linux, Solaris, etc.), a Windows® brand operating system, or any other operating system.

Electronic apparatus 100 further includes a basic input/output system (BIOS) 160. In one embodiment, BIOS 126 may be implemented in flash memory and may comprise a power-on self-test (POST) module for performing system initialization and tests. In operation, when activation of electronic apparatus 100 begins processing unit 126 accesses BIOS 122 and shadows the instructions of BIOS 122, such as power-on self-test module, into operating memory. Processor 126 then executes power-on self-test operations to implement POST processing.

In some embodiments, electronic apparatus 100 includes an access management module 128 to implement a USB port access management. In the embodiment depicted in FIG. 1, portions of access management module 128 are stored in association with BIOS 126. In alternate embodiments, access management module 128 may be stored in other memory modules associated with computer system 108.

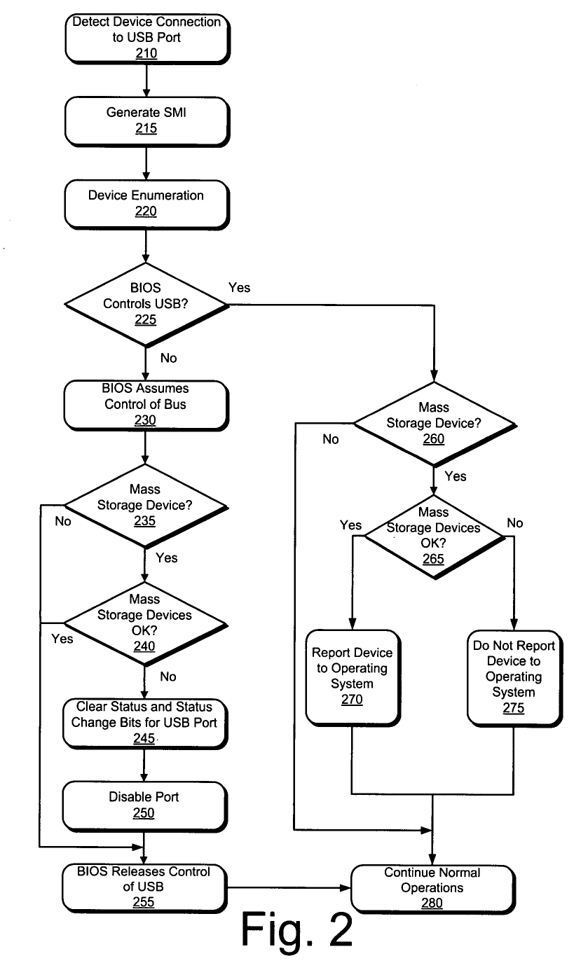

FIG. 2 is a flowchart illustrating operations implemented by access management module 128 in one embodiment of implementing USB access management. The operations depicted in FIG. 2 may be embodied as logic instructions on a computer-readable medium which may be loaded into the operating memory of the computer system and, when executed by the processing unit 122, configure the computer to implement USB port access management.

Referring to FIG. 2, at operation 210, a device connection to a USB port is detected. For example, in the embodiment depicted in FIG. 1 a device may connect to USB port 118. When the device connection is detected, e.g., by the USB host port controller, the USB port 118 generates a system management interrupt (operation 215), which suspends normal processing by processing unit 122 and places the computer 108 in system management mode. At operation 220 the system begins device enumeration for device connected to USB port 118. Device enumeration may be performed by a USB subsystem of computer 108. Device enumeration may include, for example, assigning a unique device number to the device, and reading elements of a device descriptor associated with the device.

If, at operation 225, the BIOS controls the USB bus, then control passes to operation 260. If, at operation 260, it is determined whether the device connected to the USB port comprises mass storage. As used herein, the term “mass storage” when applied to USB devices refers to a USB device that is compatible with the USB mass storage device class as defined by the USB Implementers Forum. Such devices may include, for example, external magnetic hard drives external optical drives, including CD and DVD reader and writer drives, portable flash memory devices, adapters bridging between standard flash memory cards and a USB connection, digital cameras, digital audio players, high-end hardware media players, personal data assistants and handheld computers, and mobile phones. If, at operation 260, the device connected to the USB port does not comprise mass storage, then control passes to operation 280 and normal operations are continued. By contrast, if at operation 260 the device connected to the USB port comprises mass storage, then control passes to operation 265.

At operation 265 it is determined whether the computer 108 is configured to permit mass storage devices to be connected to USB port 118. The computer 108 may be configured using a configuration utility to configure system to deny access to USB devices which comprise mass storage. In one embodiment, USB access may be configured using an F10 setup utility which resides on most computer systems, and which may be invoked by the BIOS during POST operations. The F10 setup utility permits computer system operators to configure various aspects of their computer system including, but not limited to, USB port access. The F10 setup utility is accessed by pressing the F10 key on a standard keyboard during the boot process. The BIOS detects the F10 key and, in response, invokes the F10 setup utility. Thus, at operation 265 the BIOS may consult an F10 configuration file for the computer 108 to determine whether mass storage devices are permitted.

If, at operation 265, the configuration parameter indicates that mass storage devices may be used with the USB port, then control passes to operation 270 and the device is reported to the operating system and normal operations may continue (operation 280). By contrast, if the configuration parameter indicates that mass storage devices may not be used with the USB port, then control passes to operation 275 and the device is not reported to the operating system. Thus, the operating remains unaware of the mass storage device and the device cannot be used with the computer 108. The system may invoke an error routine, wherein the error routine comprises presenting an error message on a user interface associated with the electronic apparatus. Normal operations can then continue at operation 280.

Referring back to operation 225, if the BIOS does not control the USB bus, then control passes to operation 230 and the BIOS assumes control of the USB bus. If, at operation 235, the device does not comprise mass storage, then control passes to operation 255 and the BIOS releases control of the USB bus and normal operations continue (operation 280). By contrast, if at operation 235 the device comprises mass storage, then control passes to operation 245.

If, at operation 240 the configuration parameter indicates that mass storage devices may be used with the USB port, then control passes to operation 255 and the BIOS releases control of the USB bus and normal operations continue (operation 280).

By contrast, if the configuration parameter indicates that mass storage devices may not be used with the USB port, then control passes to operation 245 and the BIOS clears the status and status change bits in the USB port, and disables the USB port (operation 250). Control then passes to operation 255 and the BIOS releases control of the USB bus and normal operations continue (operation 280).

Thus, the operations of FIG. 2 permit the electronic apparatus 100 to manage access to a USB port. As noted above, the methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A method to manage access to a USB port in an electronic apparatus having a basic input/output system and an operating system, comprising:
detecting a connection of a device to a USB port;
in response to the connection, generating a system management interrupt that causes the basic input/output system to assume control of the electronic apparatus;
determining, in the basic input/output system, whether the device comprises mass storage;
determining whether the USB port is configured to accept a device that comprises mass storage; and
initiating a routine to block access to the USB port in the event that the device comprises mass storage.

2. The method of claim 1, wherein the routine to block access to the USB port comprises:
withholding reporting of the device to the operating system in response to a determination that the basic input/output system has control of the USB port and the USB port is configured to deny access to a device that comprises mass storage.

3. The method of claim 1, wherein the routine to block access to the USB port comprises:
determining whether the operating system has control of the USB port; and
in response to a determination that the operating system has control of the USB port:
passing control of the USB port to the basic input/output system; disabling the USB port; and
returning control of the USB port to the operating system.

4. The method of claim 3, wherein disabling the USB port comprises changing at least one status bit in the USB port.

5. The method of claim 1, wherein determining whether the USB port is configured to accept a storage device that comprises mass storage comprises referencing a setup table stored in a memory module associated with the electronic apparatus.

6. The method of claim 1, wherein determining, in the basic input/output system, whether the device comprises mass storage comprises initiating an enumeration of the device.

7. The method of claim 1, further comprising storing an identifier associated with a user of the electronic apparatus in a memory location coupled to the electronic apparatus.

8. An electronic apparatus, comprising:
a processor;
an operating system;
a basic input/output system; and
logic to:
detect a connection of a device to a USB port;
in response to the connection, generate a system management interrupt that causes the basic input/output system to assume control of the electronic apparatus;
determine, in the basic input/output system, whether the device comprises mass storage;
determine whether the USB port is configured to accept a device that comprises mass storage; and
initiate a routine to block access to the USB port in the event that the device comprises mass storage.

9. The electronic apparatus of claim 8, wherein the routine to block access to the USB port comprises logic to withhold reporting of the device to the operating system in response to a determination that the basic input/output system has control of the USB port and the USB port is configured to deny access to a storage device.

10. The electronic apparatus of claim 8, wherein the routine to block access to the USB port comprises logic to:
determine whether the operating system has control of the USB port; and
in response to a determination that the operating system has control of the USB port:
pass control of the USB port to the basic input/output system;
disable the USB port; and
return control of the USB port to the operating system.

11. The electronic apparatus of claim 10, further comprising logic to change at least one status bit in the USB port.

12. The electronic apparatus of claim 8, further comprising logic to reference a setup table stored in a memory module associated with the electronic apparatus.

13. The electronic apparatus of claim 8, further comprising logic to initiate an enumeration of the device.

14. The electronic apparatus of claim 8, further comprising logic to store an identifier associated with a user of the electronic apparatus in a memory location coupled to the electronic apparatus.

15. An electronic apparatus, comprising:
a processor;
an operating system;
a basic input/output system; and
logic to manage access to one or more USB devices attached to an electronic apparatus by performing operations, comprising:
detecting whether a USB device comprises mass storage; and
disabling access to a USB device that comprises mass storage.

16. The electronic apparatus of claim 15, further comprising logic to detect whether a USB device comprises mass storage comprises referencing a setup table stored in a memory module associated with the electronic apparatus.

17. The electronic apparatus of claim 15, further comprising logic to withhold reporting of the USB device to the operating system in response to a determination that the basic input/output system has control of a USB port to which the device is connected and the USB port is configured to deny access to a device that comprises mass storage.

18. The electronic apparatus of claim 15, further comprising logic to:
determine whether the operating system has control of a USB port to which the device is connected; and
in response to a determination that the operating system has control of the USB port:
pass control of the USB port to the basic input/output system; disable the USB port; and
return control of the USB port to the operating system.

19. The electronic apparatus of claim 18, further comprising logic to change at least one status bit in the USB port.

20. The method of claim 15, further comprising logic to store an identifier associated with a user of the electronic apparatus in a memory location coupled to the electronic apparatus.

21. A method to manage access to one or more USB devices attached to an electronic apparatus, comprising:
detecting whether a USB device comprises mass storage; and
disabling access to a USB device that comprises mass storage.

22. The method of claim 21, wherein detecting whether a USB device comprises mass storage comprises referencing a setup table stored in a memory module associated with the electronic apparatus.

23. The method of claim 21, wherein disabling access to a USB device that comprises mass storage comprises withholding reporting of the USB device to the operating system in response to a determination that the basic input/output system has control of a USB port to which the device is connected and the USB port is configured to deny access to a device that comprises mass storage.

24. The method of claim 21, wherein disabling access to a USB device that comprises mass storage comprises:
determining whether the operating system has control of a USB port to which the device is connected; and
in response to a determination that the operating system has control of the USB port:
passing control of the USB port to the basic input/output system; disabling the USB port; and
returning control of the USB port to the operating system.

25. The method of claim 24, wherein disabling the USB port comprises changing at least one status bit in the USB port.

26. The method of claim 21, further comprising storing an identifier associated with a user of the electronic apparatus in a memory location coupled to the electronic apparatus.
